(19) United States
(12) Patent Application Publication
(10) Pub. No.: US 2008/0082761 A1
(43) Pub. Date: Apr. 3, 2008

(54) GENERIC LOCKING SERVICE FOR BUSINESS INTEGRATION

(76) Inventors: Eric Nels Herness, Byron, MN (US); Chendong Zou, Cupertino, CA (US)

Correspondence Address: DUKE W. YEE, P.O. BOX 802333, YEE & ASSOCIATES, P.C., DALLAS, TX, 75380, US

(21) Appl. No.: 11/536,941

(22) Filed: Sep. 29, 2006

(51) Int. Cl. G06F 12/14

(52) U.S. Cl. 711/152

(57) ABSTRACT

A generic lock manager service is provided which allows locks and lock requests to be recovered across system failures and restarts. When a lock request that includes a request to isolate a particular data object is received, the lock manager service examines a lock request queue to determine if the queue contains a second lock request for the data object specified in the lock request. If no second lock request is present, a sequence identifier is assigned to the lock request indicating a lock request processing order for the data object specified in the lock request, and the lock request is persisted in a persistent storage. If a second lock request is present, a maximum sequence identifier of all lock requests directed to the data object is identified. The next higher sequence identifier is assigned to the lock request and the lock request is also persisted in a persistent storage.

### BACKGROUND OF THE INVENTION

1. Field of the Invention

The present invention relates generally to an improved data processing system, and in particular, to a computer implemented method, data processing system, and computer program product for providing a generic lock manager service for isolating data in a business integration environment.

2. Description of the Related Art

The integration of business processes across organizations allows individuals and systems both internal and external to an enterprise to communicate and work together in support of business strategies. Clients may call out a service in the business enterprise, and the appropriate business component in the business enterprise responds to the request. In many business integration scenarios, isolation of data is needed to ensure that requests to access data from multiple users or threads occurs in a manner consistent with the integrity of the data. In the current art, the process of ‘locking’ is typically used in database systems to achieve data isolation. A lock is a mechanism for enforcing limits on access to a resource in an environment where there are many threads of execution. A resource may be locked to modification upon access by a first user, and a subsequenct user is prevented from accessing the resource until the first user has relinquished control.

Although locking may be employed with regard to database systems, there is currently no generic locking service available outside of a database system for non-database applications, such as business integration applications, to use. In addition, there are two major requirements in business integration scenarios that are unique and not satisfied by typical database locking mechanisms. The first requirement is that lock requests are often performed asynchronously. In other words, when a client requests a lock in most long-lived business processes, the client typically does not suspend its processing and wait to obtain the lock. The second requirement is that the locks and lock requests need to be persistent across system failures or restarts. Typical locking requests in databases do not survive system failures and system restarts.

### SUMMARY OF THE INVENTION

The illustrative embodiments provide a computer implemented method, data processing system, and computer program product for providing a generic lock manager service in a business integration environment that allows locks and lock requests to be recovered across system failures and restarts. When a lock request which includes a request to isolate a particular data object is received from a client, the lock manager service examines a lock request queue to determine if the lock request queue contains a second lock request for the particular data object specified in the lock request. If a second lock request is not present in the lock request queue, the lock manager service assigns a sequence identifier (ID) to the lock request, wherein the sequence ID indicates an order for processing lock requests for the particular data object specified in the lock request. The lock request is also persisted in a persistent storage to allow the lock request to be recovered across system failures or system restarts. If a second lock request is present in the lock request queue, the lock manager service identifies a maximum sequence ID of all lock requests directed to the particular data object and assigns the next higher sequence ID than the maximum sequence ID to the lock request. The lock request is also persisted in a persistent storage to allow the lock request to be recovered across system failures or system restarts.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the illustrative embodiments may be implemented;

FIG. 2 is a block diagram of a data processing system in which the illustrative embodiments may be implemented;

FIG. 3 is a block diagram of exemplary components with which the generic lock manager service in a business integration environment may be implemented;

FIG. 4 illustrates an exemplary Service Component Architecture interface supported by the generic lock manager service in accordance with the illustrative embodiments;

FIG. 5 illustrates an exemplary lock callback interface in accordance with the illustrative embodiments;

FIG. 6 illustrates an exemplary persistent lock table scheme in accordance with the illustrative embodiments;

FIG. 7 is a flowchart illustrating the processing of a lock request in accordance with the illustrative embodiments; and

FIG. 8 is a flowchart illustrating the process of removing a lock in accordance with the illustrative embodiments.

### DETAILED DESCRIPTION OF THE PREFERRED EMBODIMENT

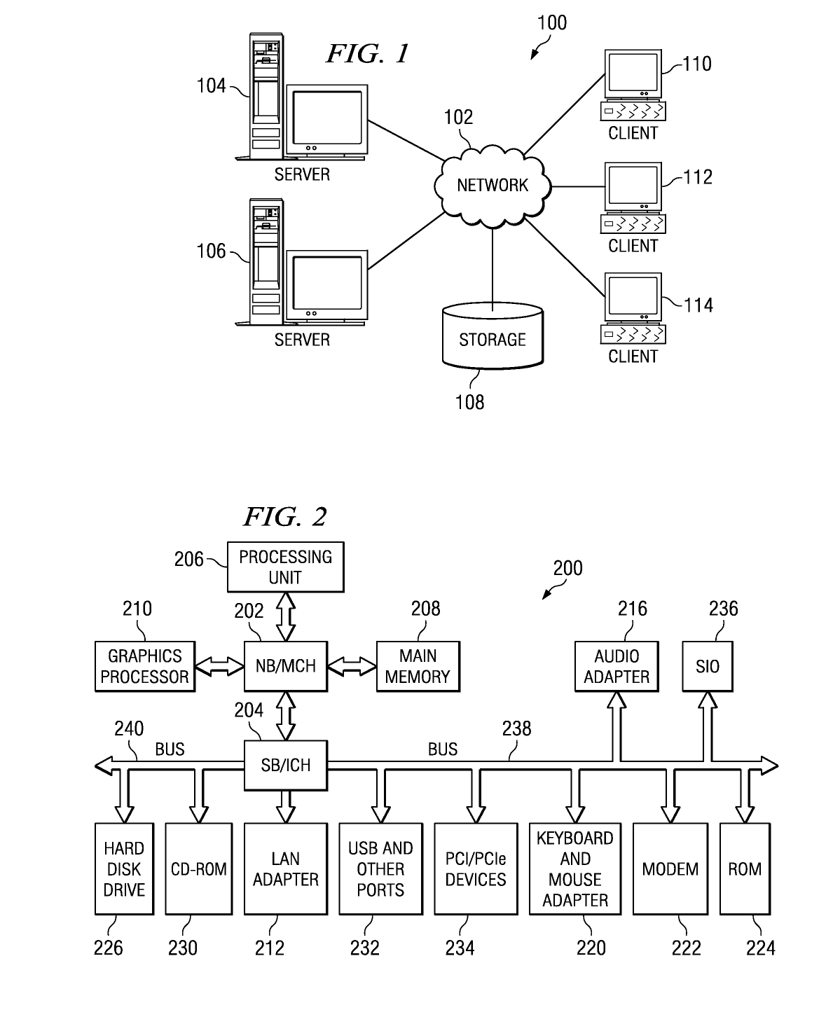

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented. Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Locks are typically employed in database systems to isolate data, such that the data cannot be accessed by another while the data is being modified. For example, if a client wants to modify data in a database, the client issues a lock request to the database system, which isolates the data by granting the lock request to the client. The client may then modify the data and the integrity of the data may be preserved. However, there is presently no generic lock manager service available outside of a database system for other non-database applications to use, such as business integration applications. For example, a client may send a service request to a business integration application, such as a banking service, to update a particular bank account, such as depositing a sum of money into the account.

The illustrative embodiments overcome the limitations in the current art by providing a generic lock manager service that allows for isolating data in business integration environments. With the generic lock manager service in the illustrative embodiments, applications in the business integration environment are allowed to perform lock requests synchronously and asynchronously. In a synchronous lock request, the client initiates the lock request and then suspends its processing while waiting for the lock to be granted. In this manner, the client waits to initiate other lock requests until the previous lock request has been granted. In an asynchronous lock request, the client initiates the lock request and then resumes its processing without waiting for a response. In other words, the requesting client may queue up multiple lock requests if the lock requests cannot be granted at that time. The lock manager service may handle the client lock request and grant the lock at a later time, at which time the client receives the lock and proceeds with its processing.

The generic lock manager service also preserves the locks and lock requests in a persistent storage, such that the locks and lock requests can be recovered across system failures or system restarts. In this manner, the lock manager service provides an extremely useful capability for long-lived business processes, such as long-lived Business Process Execution Language (BPEL) workflows, where the client may be dormant after the lock requests.

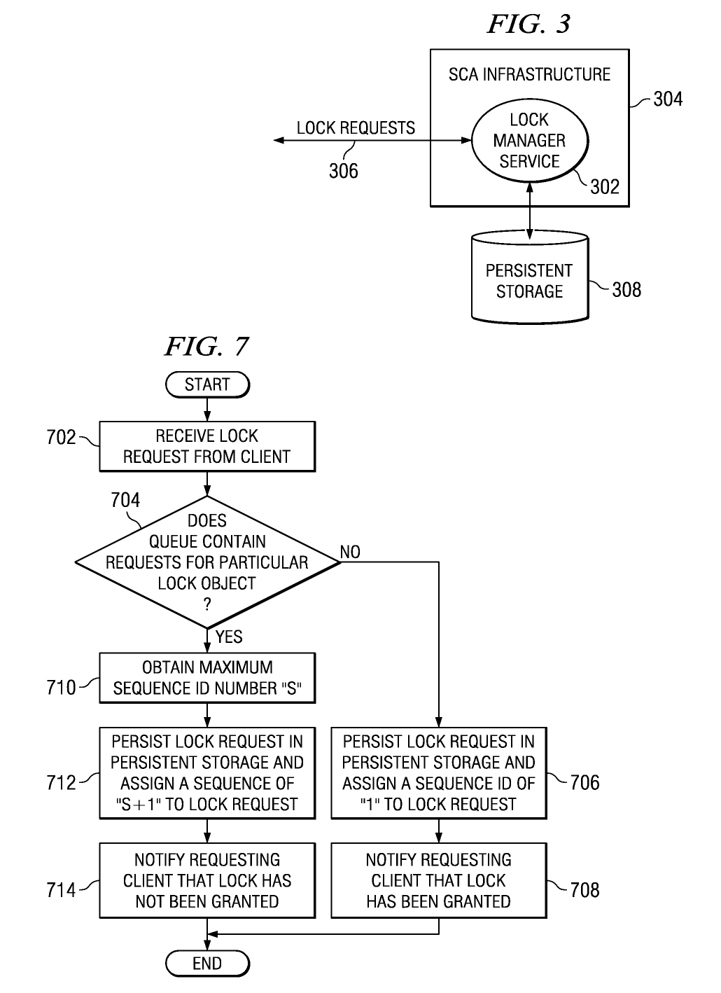

Turning now to FIG. 3, a block diagram is depicted of exemplary components with which the generic lock manager service in a business integration environment may be implemented. The components shown in FIG. 3 may be implemented in a data processing system, such as data processing system 200 in FIG. 2. In this illustrative embodiment, the generic lock manager service 302 is built on top of a Service Oriented Architecture (SOA) infrastructure, and in particular, Service Component Architecture (SCA) infrastructure 304. Advantages of building the lock manager service 302 on top of the SOA/SCA infrastructure 304 include providing SOA/SCA clients with the flexibility to call the service from anywhere the client wants, and the lock manager service may be used by any SOA/SCA client, thereby decoupling the locking service from the client. In addition, the SOA/SCA client is allowed to achieve data isolation without having to build its own lock manager service.

SCA infrastructure 304 provides a container in which components, such as lock manager service 302, may reside. Services are provided by the components and made available by the SCA. For example, an SCA client may send lock requests 306 to lock manager service 302 in SCA infrastructure 304, and in response, the lock service may grant the requested lock to the client. By exposing the lock manager service 302 as an SCA service, any SCA client may be allowed to invoke this lock manager service.

In addition, lock manager service preserves locks and lock requests in persistent storage 308. Persistent storage 308 is an example of a storage unit, such as storage unit 108 in FIG. 1. Persistent storage 308 may comprise any persistent storage mechanism, including a database or file system. Locks and lock requests are stored in persistent storage 308 to allow a lock or lock request to be recovered if there is a system failure or restart.

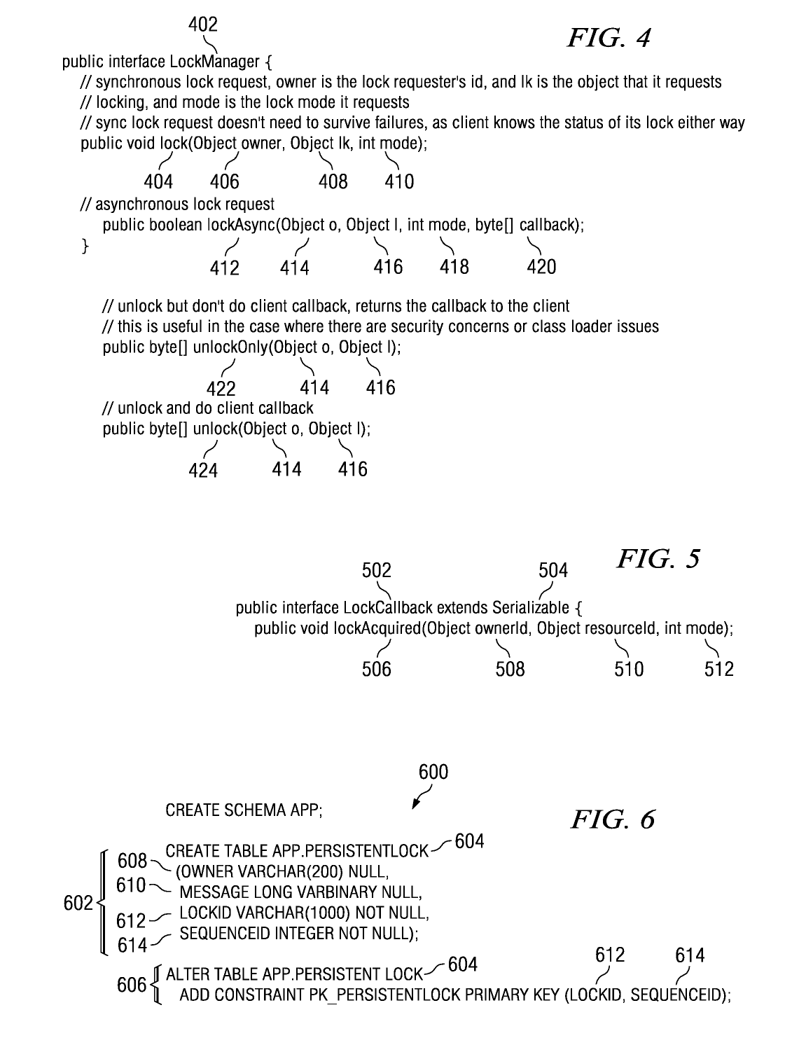

FIG. 4 is an example SCA interface supported by the generic lock manager service in accordance with the illustrative embodiments. The generic lock manager service supports an SCA interface in order to allow for synchronous and asynchronous lock requests in the business integration environment. In this illustrative embodiment, the SCA interface is LockManager interface 402. For a synchronous lock request, LockManager interface 402 includes lock method 404, which comprises parameters Object owner 406, Object lk 408, and int mode 410. Object owner 406 specifies the lock requester's ID. Object lk 408 specifies the object to be locked, such as, for example, a particular bank account. Int mode 410 specifies the lock mode requested (in this case ‘synchronous’). As synchronous lock requests are performed serially (i.e., the client initiates a lock request and ceases processing until a lock is granted), the synchronous lock request does not need to survive system failures. If a system failure does occur, the synchronous client still knows the status of the lock and can resume that lock upon restart.

For an asynchronous lock request, LockManager interface 402 includes lockAsync method 412, which comprises parameters Object o 414, Object l 416, int mode 418, and callback 420. Object o 414 specifies the lock requester's ID. Object l 416 specifies the object to be locked. Int mode 418 specifies the lock mode requested (in this case ‘asynchronous’). Callback 420 specifies the client callback interface for the asynchronous lock method to inform the client that the lock request has been granted.

LockManager interface 402 also includes unlockOnly method 422 and unlock method 424. When the requesting client completes the business process and no longer requires access to the data, unlockOnly method 422 is used to unlock the data. UnlockOnly method 422 comprises parameters Object o 414 and Object l 416. UnlockOnly method 422 only removes the lock, but does not perform a callback to the client. This UnlockOnly method 422 is useful in situations where there are security concerns or class loader issues, such as if the lockCallback has to be executed under a different security credential or in a different class loader. In situations where a callback to the client may be performed, unlock method 424 comprising parameters Object o 414 and Object l 416 may be used.

FIG. 5 illustrates an exemplary lock callback interface in accordance with the illustrative embodiments. When a client wants to request a lock asynchronously, the client uses a lock callback object, such as LockCallback interface 502, in the lock request. LockCallback interface 502 extends Serializable 504 in order to support callbacks. LockAcquired 506 comprises parameters Object ownerID 508, Object resourceID 510, and int mode 512. Object ownerID 508 specifies the lock requester's ID. Object resourceID 510 specifies the lock callback object ID. Int mode 512 specifies the lock mode requested (in this case ‘asynchronous’). LockCallback interface 502 is serializable and may be passed in by the client as a byte array as part of the lock requests.

FIG. 6 illustrates an exemplary persistent lock table schema in accordance with the illustrative embodiments. The illustrative embodiment stores each lock request persistently to promote recoverability. To ensure that the locks and lock requests survive system failures or system restarts, the locks and lock requests are stored in a persistent storage, such as persistent storage 308 in FIG. 3. Other examples of persistent storage that may be used to implement the illustrative embodiments include any storage system such as a database, file system, and the like, which can retain lock and lock request information persistently. In one embodiment, each lock request is stored as a row in a database.

Persistent lock table scheme 600 creates a schema that creates 602 and alters 606 PersistentLock table 604. PersistentLockTable 604 includes Owner 608, Message 610, LockID 612, and SequenceID 614 fields. Owner 608 field specifies the owner of the lock request. Message 610 field maps to the callback in the lockAsync 412 method in FIG. 4. LockID 612 specifies the identification (ID) of the particular lock object, and SequenceID 614 specifies the sequence number of the lock request in the lock request queue. For example, a first request for a particular lock may have a sequence ID of “1”, and a second request to the same lock may have a sequence ID of “2”, etc. Each lock request in PersistentLockTable 604 may be identified by LockID 612 and SequenceID 614.

FIG. 7 is a flowchart illustrating the processing of a lock request in accordance with the illustrative embodiments. The process begins with the lock manager service receiving a lock request from a requesting client (step 702). Upon receiving the request, the lock manager service examines the lock request queue to determine if the queue already contains one or more requests to lock the particular data object specified in the received lock request (step 704). The lock manager service may locate requests directed to the same data object by checking the queue to locate requests having the same LockID as the lock request received.

If no persistent lock request is found (a ‘no’ output to step 704) (i.e., the lock request received is the only lock request in the queue for that particular data object), the lock manager service persists the lock request in a persistent storage and assigns the lock request a sequence ID of “1” (step 706). The lock manager service then notifies the requesting client that the lock has been granted by returning a value of “true” (step 708), with the process terminating thereafter.

Turning back to step 704, if the lock manager service determines the queue already contains one or more requests to lock the particular data object (a ‘yes’ output to step 704), the lock manager service obtains the maximum sequence ID number S (step 710). The lock manager service then persists the lock request and assigns the lock request a sequence ID of “S+1” (step 712). The handling of the sequence ID number may be properly protected by either synchronizing the sequence numbers throughout the entire operation or by initiating sequence ID assignment retries in the case of conflicting/duplicating sequence numbers. Once a sequence ID is assigned, the lock manager service then notifies the requesting client that the lock has not been granted by returning a value of “false” (step 714), with the process terminating thereafter. By persisting the lock requests in a persistent storage and using a sequence number, the lock manager service may guarantee that the locks and lock requests will survive system failures and restarts, which can be critical in the business integration market.

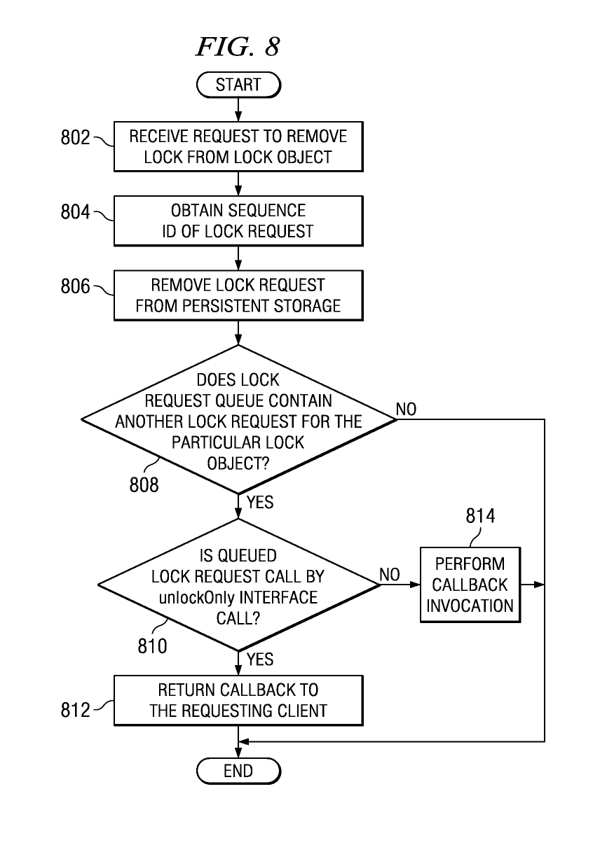

FIG. 8 is a flowchart illustrating the process of removing a lock in accordance with the illustrative embodiments. The process begins with the lock manager service receiving an unlock request to remove the lock on the particular data object (step 802). Upon receiving the unlock request, the lock manager service obtains the sequence ID of the lock request for the lock (step 804). The lock manager service removes the lock request from the persistent storage (step 806). A determination is then made as to whether the lock request queue contains another lock request for the particular data object (step 808). If the lock request queue does not contain another lock request for the particular data object (a ‘no’ output to step 808), the process terminates thereafter.

If the lock request queue does contains another lock request for the particular data object (a ‘yes’ output to step 808), a determination is then made as to whether the queued lock request is called by an unlockOnly interface call, such as unlockOnly method 422, or an unlock interface call, such as unlock method 424 in FIG. 4 (step 810).

If the queued lock request is called by the unlockOnly interface call (a ‘yes’ output to step 810), the lock manager service returns the callback to the requesting client (step 812), with the process terminating thereafter. Turning back to step 810, if the queued lock request is not called by the unlock interface call (a ‘no’ output to step 810), the lock manager service performs the callback invocation (step 814), with the process terminating thereafter.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for isolating data using lock requests, the computer implemented method comprising:
receiving a lock request from a client, wherein the lock request includes a request to isolate a particular data object;
responsive to receiving the lock request, examining a lock request queue to determine if the lock request queue contains a second lock request for the particular data object specified in the lock request;
if the second lock request is not present in the lock request queue, assigning a sequence identifier to the lock request, wherein the sequence identifier indicates an order for processing lock requests for the particular data object specified in the lock request; and
persisting the lock request in a persistent storage to allow the lock request to be recovered.

2. The computer implemented method of claim 1, further comprising:
if the second lock request is present in the lock request queue, identifying a maximum sequence identifier of all lock requests directed to the particular data object;
assigning a next higher sequence identifier than the maximum sequence identifier to the lock request; and
persisting the lock request in the persistent storage to allow the lock request to be recovered.

3. The computer implemented method of claim 1, further comprising:
responsive to receiving an unlock request to remove a lock on the particular data object, obtaining a sequence identifier of a persisted lock request associated with the lock; and
removing the persisted lock request from the persistent storage.

4. The computer implemented method of claim 3, wherein the removing step further comprises:
responsive to determining that the lock request queue contains another persisted lock request for the particular object, identifying whether the persisted lock request is called by an unlock interface call comprising a callback; and
if the unlock interface call comprises a callback, performing a callback invocation.

5. The computer implemented method of claim 1, further comprising:
responsive to assigning the sequence identifier to the lock request, notifying the client that the lock request has been granted.

6. The computer implemented method of claim 2, further comprising:
responsive to assigning the next higher sequence identifier to the lock request, notifying the client that the lock request has not been granted.

7. The computer implemented method of claim 1, wherein the persisted lock request is identified by a lock identifier and the sequence identifier.

8. The computer implemented method of claim 1, wherein the second lock request for the particular data object is identified by having a same lock identifier as the lock identifier of the lock request.

9. The computer implemented method of claim 1, wherein protection of sequence identifiers is performed by at least one of synchronizing all of the sequence identifiers or reinitiating assignment of sequence identifiers for conflicting sequence identifiers.

10. The computer implemented method of claim 1, wherein the lock request is synchronous or asynchronous.

11. The computer implemented method of claim 1, wherein the persistent storage is one of a database or a file system.

12. The computer implemented method of claim 1, wherein the receiving, examining, assigning, and persisting steps are performed by a locking service implemented as a service oriented architecture service built on a service oriented architecture infrastructure to allow the locking service to be decoupled from the client and invoked by any service oriented architecture client.

13. The computer implemented method of claim 12, wherein persisting the lock request in the persistent storage allows the locking service to serve asynchronous requests from long-lived clients where the client is dormant after the lock request.

14. A data processing system for isolating data using lock requests, the data processing system comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to receive a lock request from a client, wherein the lock request includes a request to isolate a particular data object, examine a lock request queue to determine if the lock request queue contains a second lock request for the particular data object specified in the lock request in response to receiving the lock request, assign a sequence identifier to the lock request if a second lock request is not present in the lock request queue, wherein the sequence identifier indicates an order for processing lock requests for the particular data object specified in the lock request, and persist the lock request in a persistent storage to allow the lock request to be recovered.

15. The data processing system of claim 14, wherein the processing unit further executes the computer usable code to identify a maximum sequence identifier of all lock requests directed to the particular data object if a second lock request is present in the lock request queue, assign a next higher sequence identifier than the maximum sequence identifier to the lock request, and persist the lock request in the persistent storage to allow the lock request to be recovered.

16. A computer program product for isolating data using lock requests, the computer program product comprising:
a computer usable medium having computer usable program code tangibly embodied thereon, the computer usable program code comprising:
computer usable program code for receiving a lock request from a client, wherein the lock request includes a request to isolate a particular data object;
computer usable program code for examining a lock request queue to determine if the lock request queue contains a second lock request for the particular data object specified in the lock request in response to receiving the lock request;
computer usable program code for assigning a sequence identifier to the lock request if a second lock request is not present in the lock request queue, wherein the sequence identifier indicates an order for processing lock requests for the particular data object specified in the lock request; and
computer usable program code for persisting the lock request in a persistent storage to allow the lock request to be recovered.

17. The computer program product of claim 16, further comprising:
computer usable program code for identifying a maximum sequence identifier of all lock requests directed to the particular data object if a second lock request is present in the lock request queue;
computer usable program code for assigning a next higher sequence identifier than the maximum sequence identifier to the lock request; and
computer usable program code for persisting the lock request in the persistent storage to allow the lock request to be recovered.

18. The computer program product of claim 16, further comprising:
computer usable program code for obtaining a sequence identifier of a persisted lock request associated with a lock in response to receiving an unlock request to remove the lock on the particular data object; and
computer usable program code for removing the persisted lock request from the persistent storage.

19. The computer program product of claim 16, further comprising:
computer usable program code for notifying the client that the lock request has been granted in response to assigning the sequence identifier to the lock request.

20. The computer program product of claim 16, further comprising:
computer usable program code for notifying the client that the lock request has not been granted in response to assigning the next higher sequence identifier to the lock request.
